(19) United States
(12) Patent Application Publication
(10) Pub. No.: US 2010/0138907 A1
(43) Pub. Date: Jun. 3, 2010

(54) METHOD AND SYSTEM FOR GENERATING DIGITAL CERTIFICATES AND CERTIFICATE SIGNING REQUESTS

(76) Inventors: Garret Grajek, Aliso Viejo, CA (US); Stephen Moore, Portland, OR (US); Mark Lambiase, Ladera Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 12/326,002

(22) Filed: Dec. 1, 2008

(51) Int. Cl. H04L 9/32; G06F 15/16; G06F 17/00

(52) U.S. Cl. 726/10; 709/217; 726/15

(57) ABSTRACT

A certificate server is provided for issuing digital certificates to be used by a network resource and/or a client resource. The certificate server is configured to communicate with the network resource or the client resource to receive a certificate request. Upon receiving the certificate request, the certificate server may automate the process for authenticating the certificate request, validating the terms of the certificate request and digitally signing the certificate request. An authentication appliance may communicate with or be integrated within the certificate server. The certificate server includes a web service server, a certificate authority component, and a database that enable communication with either the network resource, client resource, or the authentication appliance to automate the administration process typically involved in receiving and signing a certificate request. The certificate authority component may sign the certificate request with a trusted root chain associated with the network resource.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates to a stand alone certificate server and, more particularly, a stand alone certificate server having a web service server, a certificate authority component and a database for receiving a certificate request and signing the certificate request without requiring a manual administration process.

2. Description of the Related Art

Business and sensitive information communicated over the Internet may be susceptible to interception for malicious purposes. In order to reduce the risk of interception a client resource represented by a client, computer communicating over a network may be authenticated. Additionally, a network resource represented by a server computer also connected to the network may be authenticated. The authentication of the client resource and the network resource reduces the likelihood of sensitive information being intercepted when the information is being communicated between the client resource and the network resource.

A well known method used to authenticate the client resource and the network resource is a public key infrastructure (PKI) scheme. PKI enables computer users without prior contact to be authenticated to each other and to use the public key information in their public key certificates to encrypt messages to each other. A digital certificate is an electronic document which incorporates a digital signature to bind together a public key with an identity. Each digital certificate contains unique, authenticated information about the certificate owner. The digital certificate enables the client resource and the network resource to communicate with each other while knowing that their identities have been authenticated.

A certificate authority is an entity which issues digital certificates for use by other parties. It is an example of a trusted third party. Certificate authorities are characteristic of many public key infrastructure (PKI) schemes and may attest that the public key contained in the digital certificate belongs to the person, organization, server or other entity noted in the digital certificate. A certificate authority's obligation in such schemes is to verify the credentials of the client resource or the network resource, so that users and relying parties can trust the information in the digital certificates issued by the certificate authority.

Many certificate authorities, however, simply verify the domain name and issue the digital certificate. More advanced certificate authorities verify the existence of the business, the ownership of the domain name, and the authority to apply for a digital certificate, resulting in a higher standard of authentication. A typical PKI scheme permits each digital certificate to be signed only by a single party, the certificate authority. The digital certificate may itself be signed by a different certificate authority, all the way up to a ‘self-signed’ root certificate. Root certificates must be available to those who use a lower level certificate authority digital certificate and so are typically distributed widely. Root certificates are distributed with such applications as browsers and email clients. In this way Web pages, email messages, etc. can be authenticated without requiring the client resource to manually install a root certificate.

However, the current methods and systems used to issue digital certificates from a certificate authority are complex and not recommended for use by the casual computer user. More often, the process of issuing a digital certificate is a very user intensive manual administration process suited mainly for technologically savvy computer users. Previous methods may include processes that require the installation of one or more certificate authorities, installation and management of a certificate storage facility, installation and management of a certificate distribution point, installation and management of a certificate revocation list. All of these mechanisms may require knowledge and experience as a system administrator.

Accordingly, there exists a need in the art for an improved method and system configured to issue digital certificates which addresses one or more of the above or related deficiencies.

### BRIEF SUMMARY

The present invention specifically addresses the above-identified needs in the art. Specifically, a stand alone certificate server is provided for issuing digital certificates to be used by a network resource and/or a client resource. The certificate server is configured to communicate with the network resource or the client resource to receive a certificate request. Upon receiving the certificate request, the certificate server may automate the process for authenticating the certificate request, validating the terms of the certificate request and digitally signing the certificate request. The certificate server may communicate with an authentication appliance. Alternatively, the authentication appliance may be integrated within the certificate server. The certificate server includes a web service server, a certificate authority component, and a database that enable communication with either the network resource, client resource, or authentication appliance to automate the administration process typically involved in receiving and signing a certificate request. The certificate authority component may sign the certificate request with a trusted root chain associated with the network resource.

The web service server enables the certificate server to accept web service request calls. Upon acceptances of the web service request calls, the certificate server may receive the certificate request either from the client resource or the network resource. The web service server is used as a front end for the certificate server. The web service component accepts and authenticates the certificate request from the network resource or the client resource. The certificate server may also include a self-contained database. The database may be used to store information needed to process an incoming certificate request, store the certificate request, generate a certificate request, maintain a certificate and store certificate revocation information. The certificate server includes the components for accepting, processing, and generating certificates and certificate requests.

In further detail, a method for issuing a digital certificate using a certificate server is provided. The certificate server includes a web service server and a certificate authority component. The method may begin by establishing a secure data transfer link between the certificate server and a network resource. The secure data transfer link is established by the web service server. Subsequent to the establishment of the secure data transfer link, a certificate request may then be received by the certificate server via the secure data transfer link. The web service component may be used to receive the certificate request on the certificate server. The web service component may authenticate the source of the certificate request. As a result, the web service component may determine if the network resource is legitimate through an authentication mechanism.

The method may continue with the transfer of the certificate request from the web service server to the certificate authority component. The certificate request may then be compared with an established system parameter to determine if the certificate request meets the established system parameter. The certificate authority component may then sign the certificate request. The method may continue with the transmission of the signed certificate request to the network resource via the secure data transfer link using the web service server.

In one embodiment, the secure data transfer link is established between the certificate server and a client resource.

In another embodiment, the established system parameter to be compared with the certificate request is configured by the client resource. Alternatively, the established system parameter may be configured by the network resource. The certificate authority component may reject the certificate request when the established parameter is not met. The certificate authority component may also modify the certificate request when the established system parameter is not met rather than reject the certificate request. The certificate authority component may be configured to digitally sign the certificate request with a trusted root chain corresponding to the network resource. The certificate server may also include a self-contained database. The database may store information for processing the certificate request by the certificate authority component. The database may also store certificate revocation information corresponding to each certificate request signed by the certificate authority component.

In another embodiment, a web service client component may be stored on the certificate server. The web service client component may be configured to communicate with a licensing server and facilitates the tracking of digital certificates signed by the certificate authority component and issued by the certificate server. As a result, digital certificates that have expired may be invalidated by the certificate server. The certificate server may also include a web administration console. The web administration console enables remote access to the certificate server by a system administrator. Providing remote access to the certificate server enables the system administrator to update or change information with respect to the various components stored on the certificate server. The system administrator may also change the settings associated with the certificate server.

A method for issuing a digital certificate using a certificate server is also provided. The certificate server may include a web service server and a certificate authority component. The certificate server is in communication with an authentication appliance. The method may begin by establishing a secure data transfer link between the certificate server and the authentication appliance. The web service server may be configured to receive a certificate request from the authentication appliance via the secure data transfer link. The web service server may then authenticate the certificate request to validate the source of the certificate request. The method may continue with the transfer of the certificate request from the web service server to the certificate authority component. The certificate authority component compares the certificate request with established parameters to ensure that the certificate request complies with the established parameters. After the comparison is completed, the certificate authority component may digitally sign the certificate request and transfer the signed certificate request to the web service server. The web service server is configured to transmit the signed certificate request to the authentication appliance via the secure data transfer link. In one embodiment, the authentication appliance is integrated with the certificate server so that the certificate server may authenticate a client resource or a network resource.

A system for issuing digital certificates is further provided. The system includes a certificate server. The certificate server may include a web service server. The web service server is configured to receive a certificate request. Upon receiving the certificate request, the web service server may authenticate the source of the certificate request. The system may also include a certificate authority component and communicates with the web service server. The certificate authority component receives the certificate request from the web service server and then digitally signs the certificate request, whereby the signed certificate request may then be transmitted to a client resource via the web service server. The system may be in communication with an authentication appliance for receiving the certificate request. In another embodiment, the system includes the authentication appliance. The system may also include a database for storing information to process the certificate request by the certificate authority component. The system may also include a web administration console for providing remote access to the certificate server by a system administrator.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart illustrating a method for issuing a digital certificate using a stand alone certificate server in accordance with an aspect of the present invention;

FIG. 2 is a first exemplary configuration of the certificate server, a network resource and a client resource;

FIG. 3 is a second exemplary configuration of the certificate server in communication with an authentication appliance;

FIG. 4 is a third exemplary configuration of the certificate server communication with a database stored therein;

FIG. 5 is a fourth exemplary configuration of the certificate server; and

FIG. 6 is a configuration of the certificate server with an authentication appliance.

### DETAILED DESCRIPTION

The above description is given by way of example, and not limitation. Given the above disclosure, one skilled in the art could devise variations that are within the scope and spirit of the invention disclosed herein, including various ways of signing a certificate request using a stand alone certificate server. Further, the various features of the embodiments disclosed herein can be used alone, or in varying combinations with each other and are not intended to be limited to the specific combination described herein. Thus, the scope of the claims is not to be limited by the illustrated embodiments.

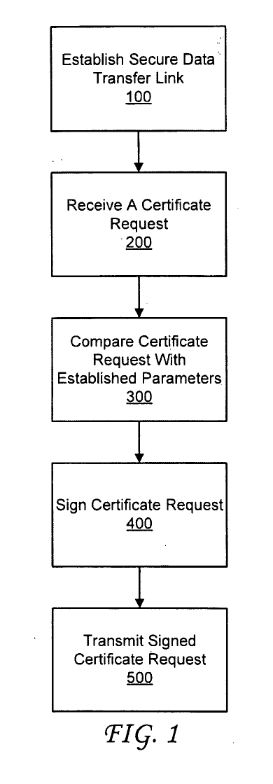

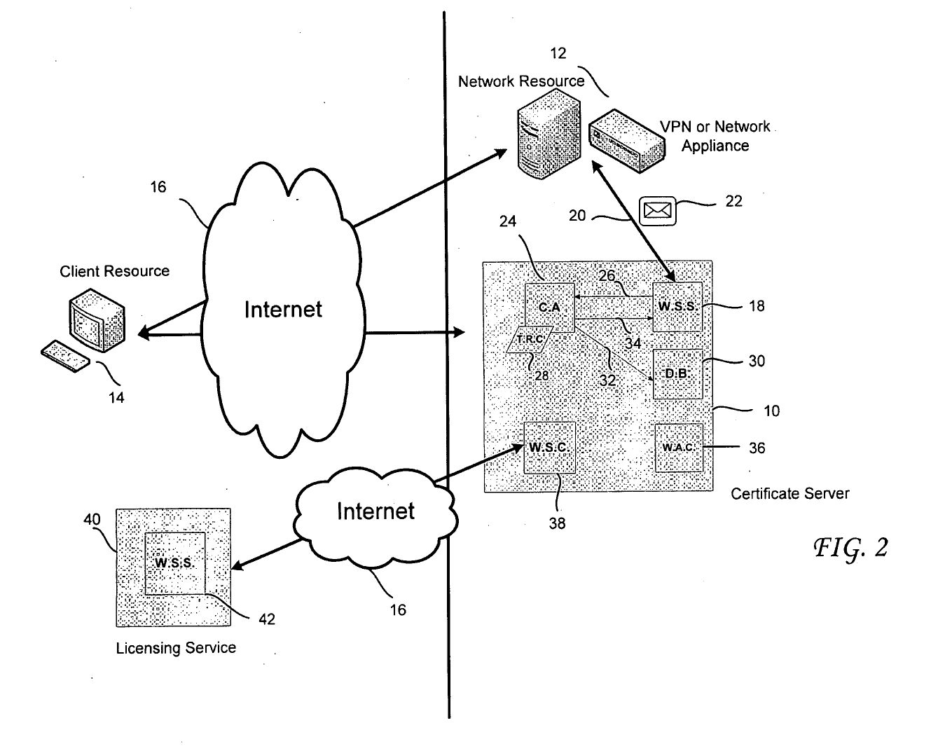

The method of issuing a digital certificate using a stand alone certificate server 10, as referenced in FIGS. 2-6, may begin with the step of establishing a secure data transfer link 100 shown in FIG. 1. To that end, the secure data transfer link is established between the certificate server 10 and a network resource 12 shown in FIG. 2. Alternatively, the secure data transfer link may also be established between the certificate server 10 and a client resource 14.

The network resource 12 may be a computer that provides data or services to the client resource 14. It is further understood that the network resource 12 as used herein may also refer generally to networked services such as a Secure Sockets Layer/Transport Layer Security (SSL/TLS) Virtual Private Network (VPN), through which data and applications to the remote client resource 14 is provided. The client resource 14 may be a computer that requests data or services from the network resource 12. Both the client resource 14 and the network resource 12 may be connected to a wide area network such as the Internet 16. In one embodiment, the network resource 12 is a web server, and the client resource 14 may include a web browsing application that visually renders documents provided by the network resource 12. Communications flowing back and forth between the network resource 12 and the client resource 14 over the Internet 16 may be susceptible to interception or theft. To reduce the likelihood of interference, a digital certificate may be issued that allows the network resource 12 and the client resource 14 to encrypt information over the Internet 16 and to guarantee the source of the information.

The network resource 12 may determine that the client resource 14 should be granted a digital certificate. The digital certificate that may be granted is an X.509 v3 certificate by way of example and not of limitation. It is understood that many different digital certificates may be issued in accordance with the certificate server 10 provided. The network resource 12 may then contact the certificate server 10 to begin the process for issuing the digital certificate. The network resource 12 initiates a communication session with the certificate server 10 so that a digital certificate may be issued to the client resource 14.

The certificate server 10 includes a web service server 18 that establishes the secure data transfer link 20 between the network resource 12 and the certificate server 10. The web service server 18 may act as a generic front end to the certificate server 10. The web service server 18 may automate the communication back forth between the certificate server 10 and the network resource 12 or the client resource 14. Additionally, the web service server 18 may be configured to translate the information received on the certificate server 10 to facilitate the issuance of a digital certificate without requiring a manual administrator process. The web service server 18 may accept a certificate request 22 transmitted by the network resource 12. Subsequent to receiving the certificate request 22, the web service server 18 may authenticate the source of the certificate request 22. The source of the certificate request 22 may be the client resource 14 or the network resource 12. A signed certificate request 22 becomes a digital certificate that may be used by the client resource 14 and the network resource 12 to communicate securely over the Internet 16.

The web service server 18 may use trusted authentication mechanisms such as WSE 3.0 for example, to authenticate the validity of the network resource 12 and/or the client resource 14 attempting to access the certificate server 10.

Referring back to FIG. 1, after the web service server 18 establishes the secure data transfer link 20 between the certificate server 10 and the network resource 12, the next step may include receiving a certificate request 200. Referring again to FIG. 2, the certificate request 22 is received by the certificate server 10. In particular, the certificate request 22 is received by the web service server 18. Upon receiving the certificate request 22, the web service server 18 authenticates the source of the certificate request 22. The authentication step facilitated by the web service server 18 may determine the validity of the network resource 12 attempting to access the certificate server 10. In another embodiment, the web service server 18 establishes the secure data transfer link 20 directly with the client resource 14. In this regard, the web service server 18 may authenticate the validity of the client resource 14 upon receiving the certificate request 22.

The certificate request 22 may be transmitted to the certificate server 10 in the form of a Public Key Cryptography Standard (PKCS) #10. The certificate request 22 may consist of three parts: certification request information, a signature algorithm identifier, and a digital signature on the certification request information. The certification request information consists of the resource's name, the resource's public key, and a set of attributes providing other information about the entity. The process by which a certification request is constructed involves a CertificationRequestInfo value containing a subject name, a subject public key, and optionally a set of attributes is constructed by an entity requesting certification. The CertificationRequestInfo value is signed with the subject resource's private key. The CertificationRequestInfo value, a signature algorithm identifier, and the resource's signature are collected together into a CertificationRequest value. The web service server 18 fulfills the certificate request 22 by authenticating the requesting network resource 12 and verifying the network resource's signature. A certificate authority component 24 may construct an X.509 certificate from the name and public key, the issuer name. The certificate authority component 24 may assign a serial number if the certificate request 22 is valid as determined by the web service server 18 and the certificate authority component 24.

After the source of the certificate request 22 is validated by the web service server 18, the certificate request 22 is transferred 26 to the certificate authority component 24. The certificate authority component 24 is stored on the certificate server 10 and used to digitally sign the certificate request 22. The certificate authority component 24 may be configured to sign the certificate request 22 with a trusted root certificate 28 corresponding to the network resource 12. The trusted root certificate 28 allows the certificate server 10 to issue digital certificates that map to the network resource's 12 own certificate domain.

Prior to signing the certificate request 22, the certificate authority component 24 compares the certificate request 22 with established parameters 300 as provided in the flow chart of FIG. 1. In other words, the certificate authority component 24 inspects the certificate request 22. The certificate authority component 24 compares the certificate request 22 against policies as established by the network resource 12 or the client resource 14. The certificate authority component 24 compares the data contained in the certificate request 22 against templates, tables or other data structures to assure the certificate request 22 is within the parameters established for the network resource 12 or the client resource 14. The certificate authority component 24 may reject the certificate request 22 if the certificate request violates the policy or is not within the established parameters. Alternatively, the certificate authority component 24 may assign or change the values associated with the certificate request 22 in order to satisfy policy or be within the established parameters. For example, if the duration of the certificate according to the policies of the network resource 12 must be less than 50 days, then a certificate request with a duration value of 51 days may be rejected or changed to satisfy the 50 day duration limitation.

The certificate server 10 may also include a database 30. The database 30 may contain information needed to issue valid certificates, authenticate valid requesting resources; store certificates issued and store certificate revocation information. Therefore the database 30 may be in communication with the certificate authority component 24 and the web service server 18. For the step where the certificate authority component 24 compares the certificate request 22 with established parameters 300, the certificate authority component 24 may access via 32 the database 30 to obtain the established parameters that may be used in the comparison with the received certificate request 22. Subsequent to the step of comparing the certificate request 22 with the established parameters, the certificate authority component 24 may digitally sign the certificate request 400. The signed certificate request 22 is then transferred 34 from the certificate authority component 24 to the web service server 18. The web service server 18 may transmit the signed certificate request 500 to the network resource 12 or directly to the client resource 14. In one embodiment, the network resource 12 may include a proxy mechanism used to receive the signed certificate request 22 from the certificate server 10 and then automatically transfer the signed certificate request 22 to the client resource 14. The client resource 14 may then use the signed certificate request 22 to generate a public/private key pair for secure access to the network resource 12.

The signed certificate request generated at the certificate server 10 may be transmitted in the form of a PKCS #7 response to the original PKCS #10 certificate request 22 requested by the network resource 12. The PKCS #7 responses may be an X.509 certificate request response. The certificate request response is a signed certificate request. Thus, after the certificate authority component 24 generates the signed certificate request, the digital certificate is transmitted to the network resource 12 in the form of the signed certificate request.

PKCS #7 is used to sign and/or encrypt messages under a PKI scheme. PKCS #7 may also be used for certificate dissemination in response to a PKCS #10 certificate request 22. For each signer, a message digest is computed on the content with a signer-specific message-digest algorithm. If the signer is authenticating any information other than the content, the message digest of the content and the other information are digested with the signer's message digest algorithm, and the result becomes the message digest. For each signer, the message digest and associated information are encrypted with the signer's private key. For each signer, the encrypted message digest and other signer-specific information are collected into a SignerInfo value. Certificates and certificate-revocation lists for each signer, and those not corresponding to any signer, are collected in this step. The message-digest algorithms for all the signers and the SignerInfo values for all the signers are collected together with the content into a SignedData value. A recipient verifies the signatures by decrypting the encrypted message digest for each signer with the signer's public key, then comparing the recovered message digest to an independently computed message digest. The signer's public key is either contained in a certificate included in the signer information, or is referenced by an issuer name and an issuer-specific serial number that uniquely identify the digital certificate for the public key.

When the client resource 14 receives the PKCS #7 signed certificate request that was signed by the certificate authority component 24 the client resource 14 may generate a corresponding client certificate and a public and private key pair.

The certificate server 10 may also include a web administration console 36. The web administration console (W.A.C.) 36 of the certificate server 10 may contain a web interface that allows remote access by a system administrator via a web browser to configure the certificate server 10. The web administration console 36 enables the system administrator to access and configure the certificate server 10 and the various components stored therein. The system administrator may push a certificate revocation list (CRL) to the network resource 12 using immediate root and intermediate certificate authority CRL publication interfaces. The system administrator may disable an account and/or a digital certificate through an immediate user database account disablement interface. The web administration console 36 may also include a user certificate search interface that can assist with certificate revocation for client resources or network resources with multiple issued certificates. The system administrator may search a list of certificates issued per user and show all certificates issued to the client resource 14 or network resource 12 for revocation. The web administration console 36 may also include a temporary certificate revocation interface which allows an administrator to temporarily or permanently revoke the digital certificate. The web administration console 36 may also include a CRL availability/validity interface that may function as a test button to determine availability of the certificate. A certificate server replication configuration interface may also be provided which allows for multiple certificate servers to work in a high availability environment. Another interface includes IPSec certificate authority firewall configuration interface that may allow a firewall to be installed/configured on the certificate server 10. A user database/connector configuration and testing interface may be used to configure the database 30 so that the certificate server 10 may access client resource certificate information. The above interfaces associated with the web administration console 36 are by way of example only and not meant to limit the quantity and type of interfaces that may correspond to the web administration console 36.

Still referring to FIG. 2, the certificate server 10 may also include a web service client component 38. The web service client component 38 may access a licensing service 40 via the Internet 16. The licensing service 40 may include a web service server 42 configured to establish a secure communication link between the licensing service 40 and the certificate server 10. The licensing service 40 may keep track of the valid certificate servers and how many certificates the certificate server 10 may be able to issue.

The various components associated with the certificate server 10 facilitate communication with the network resource 12, the client resource 14 and the licensing service 40 to issue digital certificates by signing certificate requests 22. The certificate server 10 may automate and override the manual administrator process typically involved for issuing certificates using a certificate authority.

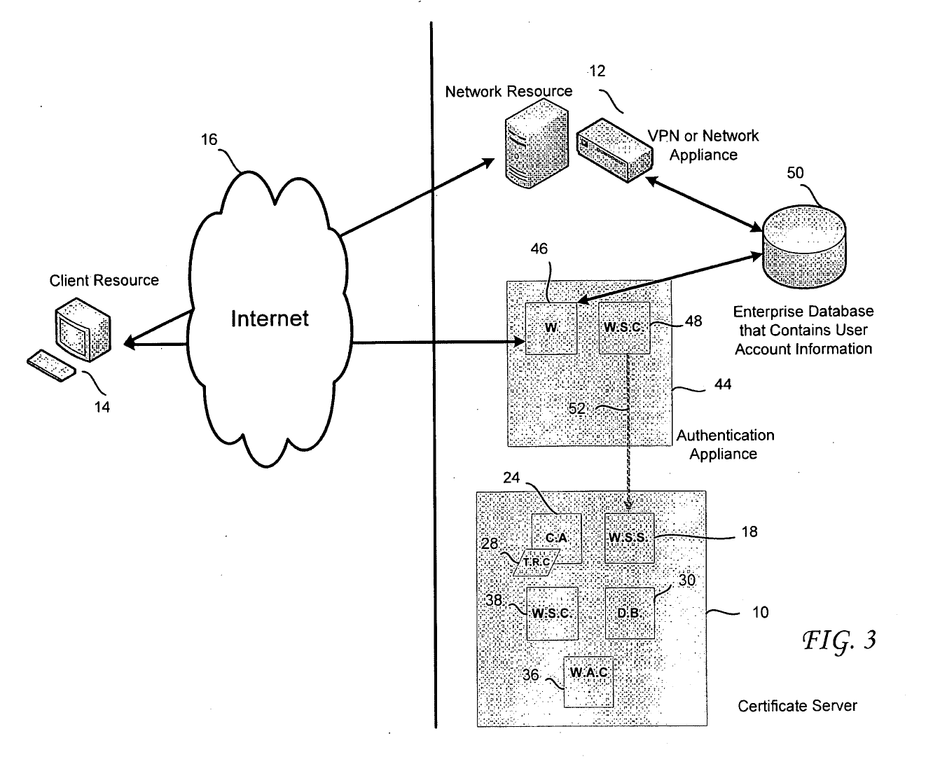

Referring now to FIG. 3, an authentication appliance 44 is provided for authenticating the client resource 14 and the network resource 12. The authentication appliance 44 may include the authentication appliance disclosed in U.S. patent application Ser. No. 11/880,599, the teachings of which are incorporated herein by reference. As a result, the certificate server 10 may be configured to communicate with the authentication appliance 44 rather than communicating directly with the client resource 14 or the network resource 12. The advantage being the issuance of a digital certificate by the certificate server 10 in response to the authentication appliance 44 authenticating the client resource 14 and the network resource 12.

The authentication appliance 44 includes a web service component 46. The web service component 46 is an interface that a user on the client resource 14 may see when attempting to conduct an authentication with the network resource 12. The web service component 46 is a set of pages and executables that step the user of the client resource 14 through the process of collecting the appropriate user id, registration information and password information. The web service component 46 may include a workflow engine that keeps track of what state the client resource 14 is in relative to the authentication process and conducts the authentication workflow accordingly. The authentication appliance 44 may also include a web service client component 48 configured to initiate a communication link 52 between the authentication appliance 44 and the certificate server 10. The communication link 52 may be established after the client resource 14 and the network resource 12 are authenticated.

The client resource 14 may initiate a connection to the network resource 12 with a conventional web browser, the network resource 12 searches the client resource 14 for a pre-existing client certificate. Finding none, the network resource 12 may generate a certificate transfer instruction to the dedicated authentication appliance 44. The authentication appliance 44 may direct a telephony server to deliver a one-time-password or authoritative response to a cellular phone, landline phone, or e-mail address previously known to be under the control of a user of the client resource 14. The one-time-password may be delivered over a communications modality that is independent of, or out-of-band with respect to, the data communication link between the client resource 14 and the network resource 12. The telephony sever may be managed by a third party, or by the organization that manages the network resource 12. The authentication appliance 44 directs the user on the client resource 14 to enter the authoritative response.

Additionally, the authentication appliance 44 may query the network resource 12, to ensure that the client resource 14 has the authorization to access any resources thereon as a secondary authentication modality. It is contemplated that a database 50 has associated therewith its own username/password authentication scheme, and the authentication appliance 44 queries it. The database 50 may be an Active Directory server, a Lightweight Directory Access Protocol (LDAP) server, a database server, and so forth. Upon successfully authenticating the client resource 14, the authentication appliance 44 directs the certificate server 10 to generate a client certificate and a client private key. The client certificate and the client private key are transmitted first to the authentication appliance 44, which transmits the same to the client resource 14 for storage thereon.

The authentication appliance 44 is configured to connect to the database 50 to extract relevant information about the client resource 14. This information may include: user id, SMS, mobile phone, phone, e-mail, static token password and/or user account password. In this regard, the authentication appliance 44 may authenticate the client resource 14 and the network resource 12. After completing the authentication, the authentication appliance 44 using the web service client component 48 may transmit the certificate request 22 to the web service server 18 on the certificate server 10. In this scenario, the authentication appliance 44 is an intermediary between the client resource/network resource 12, 14 and the certificate server 10.

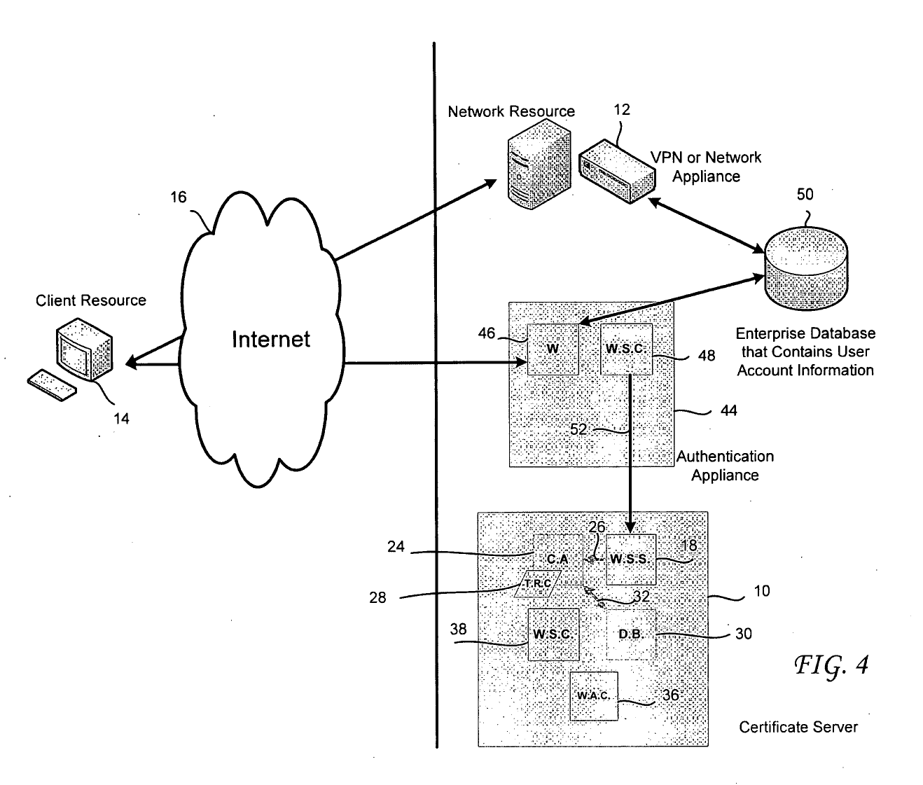

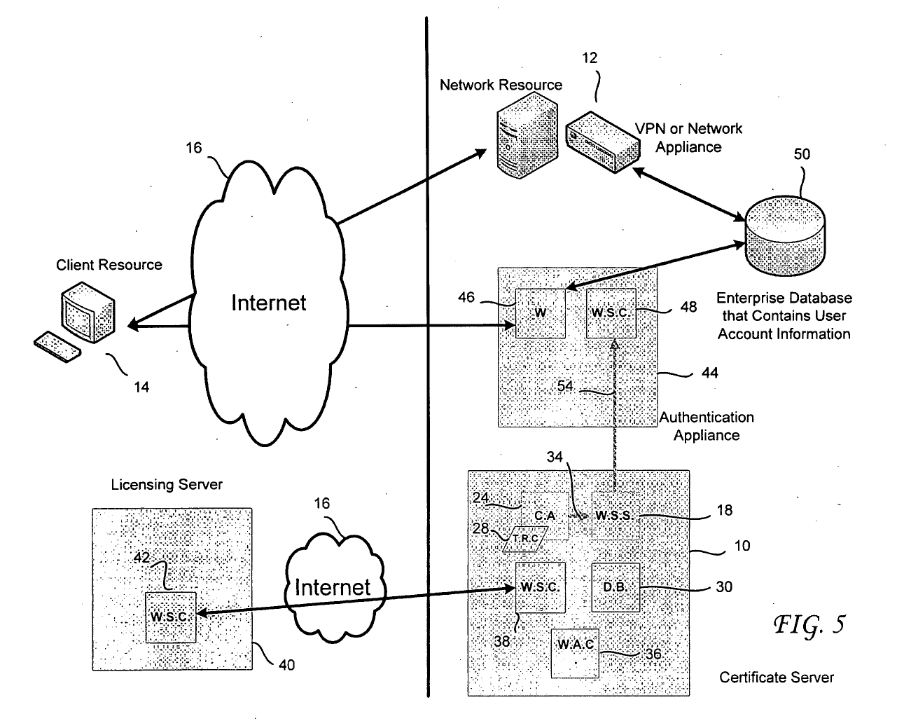

Referring now to FIGS. 4 and 5, the web service client component 48 of the authentication appliance 44 may initiate a communication link 52 with the certificate server 10. In response, the web service server 18 on the certificate server 10 may establish a secure data transfer link to receive the certificate request 22. After authenticating the source of the certificate request 22, the web service server 18 may transfer 26 the certificate request 22 to the certificate authority component 24. The certificate authority component 24 may access 32 the database 30 to compare the established parameters for the certificate request 22 with the actual certificate request 22. After comparing the certificate request 22 with the established parameters, the certificate authority component 24 may digitally sign the certificate request 22 and transfer 34 the signed certificate request 22 to the web service server 18. The web service server 18 may then transmit 54 the signed certificate request 22 to the authentication appliance 44.

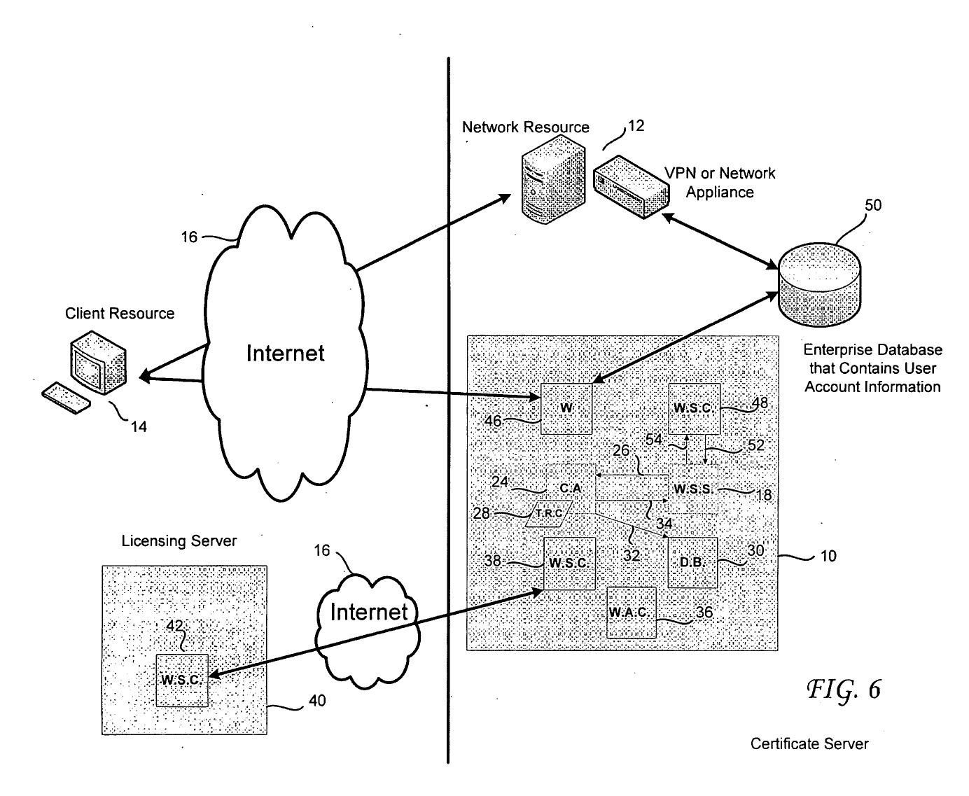

Referring now to FIG. 6, the certificate server 10 includes the web service component 46 and the web service client component 48 that comprises the authentication appliance 44. In this embodiment, authentication appliance 44 is integrated within the certificate server 10. The certificate server 10 may be configured to authenticate the network resource 12 and the client resource 14 in addition to signing the certificate request 22 for issuing the digital certificate. The certificate server 10 may be called upon to authenticate a user of the client resource 14. The certificate server 10 using the web service component 46 may step the client resource 14 through the relevant authentication methodologies. The web server client component 48 may then make a web services or some other request to the web service server 18 for a certificate signing. In this scenario the certificate request 22 has actually commenced from the client resource 14. The certificate request 22 may be passed to the certificate server 10 securely via a WSE 3.0 Web Service request.

The certificate request 22 may not be transmitted to the certificate server 10 prior to establishing the secure data transfer link 20 between the network resource 12 and the certificate server 10. The certificate server 10 is configured to register the client resource 14 with the network resource 12 and successfully complete a multi-factor authentication process to ensure that the client resource 14 is not an impostor or hacker to secure all communications between the client resource 14 and the network resource 12. In this embodiment, the web service client component 48 may directly communicated with the web service server 18 to transmit the certificate request 22 and receive the signed certificate request 22. In this regard, the certificate server 10 is configured to generate the certificate request 22 in response to receiving a certificate transfer instruction from either the client resource 14 or the network resource 12.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for issuing a digital certificate using a certificate server having a web service server and a certificate authority component, the method comprising:
establishing a secure data transfer link between the certificate server and a network resource using the web service server;
receiving a certificate request on the web service server;
authenticating the certificate request using the web service server, the web service server being in communication with the certificate authority component;
transferring the certificate request from the web service server to the certificate authority component;
comparing the certificate request with an established system parameter to determine if the certificate request meets the established system parameter;
signing the certificate request by the certificate authority component; and
transmitting the signed certificate request to a client resource via the secure data transfer link.

2. The method of claim 1, wherein the secure data transfer link is established between the certificate server and a client resource.

3. The method of claim 2, wherein the established system parameter is configured by the client resource.

4. The method of claim 1, wherein the established system parameter is configured by the network resource.

5. The method of claim 1, wherein the certificate authority component rejects the certificate request when the established system parameter is not met.

6. The method of claim 1, wherein the certificate authority component modifies the certificate request to fulfill the established system parameter.

7. The method of claim 3, wherein the certificate authority component digitally signs the certificate request with a trusted root chain corresponding to the network resource.

8. The method of claim 1, further comprising a database stored on the certificate server, the database configured to store information for processing the certificate request by the certificate authority component.

9. The method of claim 8, wherein the database stores certificate revocation information corresponding to each certificate request signed by the certificate authority component.

10. The method of claim 1, further comprising a web service client component stored on the certificate server, the web service client component configured to communicate with a licensing server to track the digital certificates issued by the certificate server.

11. The method of claim 1, further comprising a web administration console configured to allow remote access to the certificate server.

12. A method for issuing a digital certificate using a certificate server having a web service server and a certificate authority component, the certificate server being in communication with an authentication appliance, the method comprising:
establishing a secure data transfer link between the certificate server and the authentication appliance;
receiving a certificate request on the web service server from the authentication appliance via the secure data transfer link;
authenticating the certificate request using the web service server, the web service server being in communication with the certificate authority component;
transferring the certificate request from the web service server to the certificate authority component;
comparing the certificate request with an established system parameter to determine if the certificate request meets the established system parameter;
signing the certificate request by the certificate authority component; and
transmitting the signed certificate request to the authentication appliance via the secure data transfer link.

13. The method of claim 12, wherein the authentication appliance is stored on the certificate server.

14. A system for issuing digital certificates, comprising:
a certificate server including:
a web service server for receiving a certificate request, the web service server configured to authenticate the certificate request; and
a certificate authority component in communication with the web service server, the certificate authority component receiving the certificate request from the web service server, the certificate authority component configured to sign the certificate request, the signed certificate request being transmitted to a client resource.

15. The system of claim 14, wherein the certificate authority component is configured to compare the certificate request with an established system parameter to determine if the certificate request meets the established system parameter.

16. The system of claim 14, wherein the certificate server is in communication with an authentication appliance for receiving the certificate request.

17. The system of claim 14, further comprising an authentication appliance for authenticating the client resource prior to the signing of the certificate request by the certificate authority component.

18. The system of claim 14, further comprising a database for storing information to process the certificate request by the certificate authority component.

19. The system of claim 14, further comprising a web administration console for providing remote access to the certificate server by a system administrator.
